(19) United States
(12) Patent Application Publication
(10) Pub. No.: US 2014/0009124 A1
(43) Pub. Date: Jan. 9, 2014

(54) PARTIAL HOT PLUG PROTECTION CIRCUIT FOR SUPER CAPACITOR TEMPERATURE SENSOR

(71) Applicants: R. Brian Skinner, Gainesville, GA (US); Lakshmana M. Anupindi, Suwance, GA (US); Jeffrey Inskeep, Marietta, GA (US)

(72) Inventors: R. Brian Skinner, Gainesville, GA (US); Lakshmana M. Anupindi, Suwance, GA (US); Jeffrey Inskeep, Marietta, GA (US)

(21) Appl. No.: 13/544,095

(22) Filed: Jul. 9, 2012

(51) Int. Cl. H02J 7/00

(52) U.S. Cl. 320/166

(57) ABSTRACT

An apparatus comprising a capacitor circuit, a control circuit, and a resistor circuit. The capacitor circuit may be configured to (i) be charged through an input terminal and (ii) store a charge sufficient to run a device on an output terminal. The control circuit may be configured to (i) charge the capacitor through the input terminal, (ii) couple the input terminal to a voltage source, and (iii) discharge the capacitor circuit when the output terminal is not connected to the device drive.

### FIELD OF THE INVENTION

The present invention relates to protection circuits generally and, more particularly, to a method and/or apparatus for implementing a partial hot plug protection circuit for super capacitor temperature sensor.

### BACKGROUND OF THE INVENTION

Conventional backup power supplies implement battery packs or capacitor banks to provide power to computers. The backup supplies continue to power the computers (such as network servers, or important work stations) when the line voltage is interrupted.

It would be desirable to implement a partial hot plug protection circuit for a temperature sensor in a capacitor package.

### SUMMARY OF THE INVENTION

The present invention concerns an apparatus comprising a capacitor circuit, a control circuit, and a resistor circuit. The capacitor circuit may be configured to (i) be charged through an input terminal and (ii) store a charge sufficient to run a device drive on an output terminal. The control circuit may be configured to (i) charge the capacitor through the input terminal, (ii) couple the input terminal to a voltage source, and (iii) discharge the capacitor circuit when the output terminal is not connected to the device drive.

The objects, features and advantages of the present invention include providing a protection circuit that may (i) implement a partial hot plug, (ii) ensure that a partially charged capacitor bank does not AC couple into a ground pin, (iii) provide a safe discharge of a capacitor pack, and/or (iv) be cost effective to implement.

### BRIEF DESCRIPTION OF THE DRAWINGS

These and other objects, features and advantages of the present invention will be apparent from the following detailed description and the appended claims and drawings in which:

FIG. 1 is a block diagram of an example implementation of the invention;

FIG. 2 is a block diagram of a capacitor circuit;

FIG. 3 is a block diagram of a temperature sensor;

FIG. 4 is a plot of the capacitor circuit during a hot-plug operation without the control circuit; and

FIG. 5 is a plot of the capacitor circuit during a hot-plug operation with the control circuit.

### DETAILED DESCRIPTION OF THE PREFERRED EMBODIMENTS

The present invention may use one or more P-channel FET and/or N-channel transistors to isolate a power path of a capacitor pack. In one example, a capacitor pack may refer to a discrete package that may be implemented separately from a device such as a controller board. In another example, the capacitor pack may refer to a group of capacitors fabricated along with another device, such as a controller board. A control circuit may be used to prevent a fully charged (or partially charged) capacitor pack from AC coupling energy into one or more ground pins of one or more active Integrated Circuits (ICs) (e.g., a temperature sensor) in a configuration using the capacitor pack. While a temperature sensor has been described generally, the particular type of active IC protected may be varied to meet the design criteria of a particular implementation.

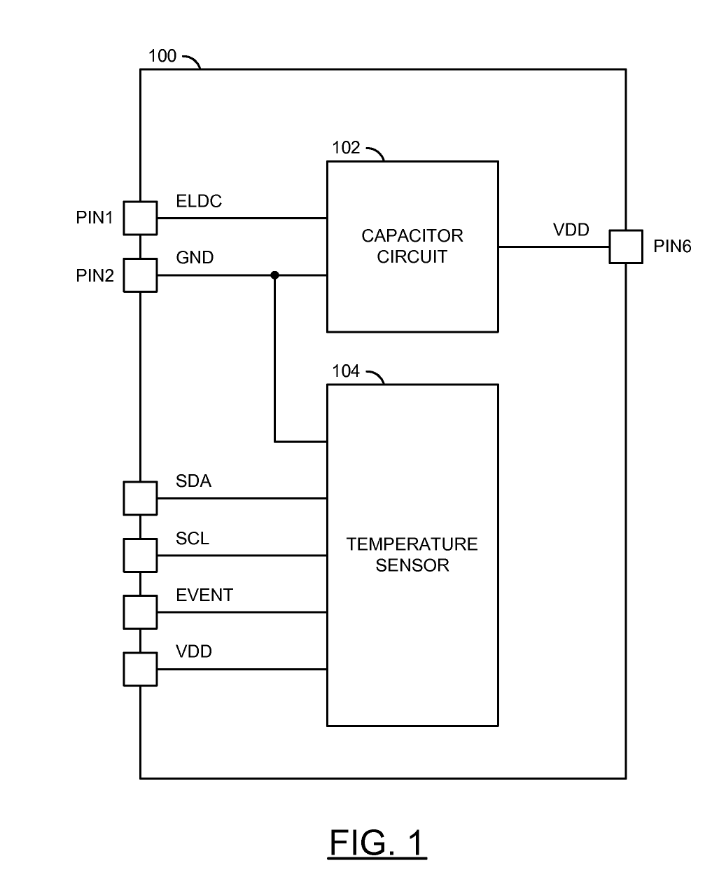

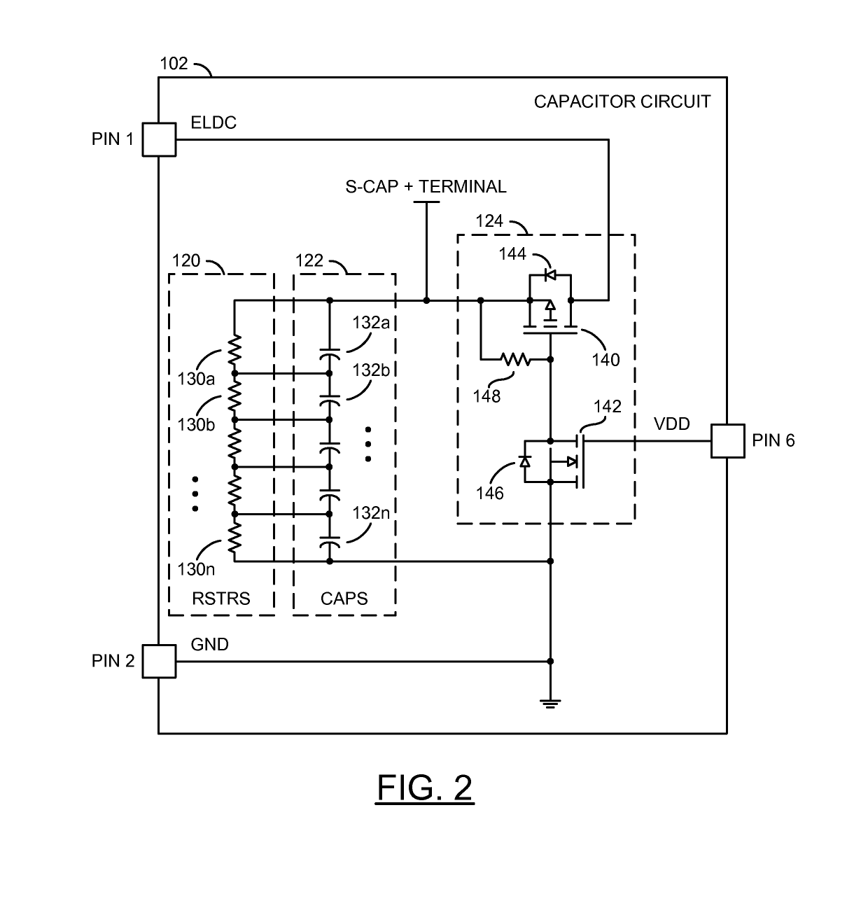

Referring to FIG. 1, a block diagram of a circuit 100 is shown in accordance with an embodiment of the present invention. The circuit 100 generally comprises a block (or circuit) 102 and a block (or circuit) 104. The circuit 102 may be implemented as a capacitor circuit. The circuit 104 may be implemented as a temperature sensor circuit. The capacitor circuit 102 and the temperature sensor circuit 104 may be implemented, in one example, on one device (or circuit board). In another example, the capacitor circuit 102 and the temperature sensor circuit 104 may be implemented on separate devices (or circuit boards) and may be connected together using a bus. The capacitor circuit 102 may be implemented as a number of individual capacitors (to be described in more detail in connection with FIG. 2). The capacitor circuit 102 may receive a supply voltage (e.g., ELDC) through an IO pin (e.g., PIN), a ground (e.g., GND) through a pin (e.g., PIN2), and may present an input (e.g., VDD) through a pin (e.g., PIN6).

The current into or out of a capacitor circuit 102 is normally enabled (or disabled) by the use of a control circuit (to be described in more detail in connection with FIG. 2). With the control circuit in place, current is normally prevented from flowing from a partially charged capacitor circuit 102 into the capacitive load of a dead card (e.g., +3.3 VDC). The control circuit may prevent an AC coupled voltage from appearing on the GND pin of the temperature sensor 104 (or any other IC in the capacitor pack) that shares a common GND with the capacitor circuit 102.

The capacitor circuit 102 may include control circuitry that may respond to an input voltage VDD (to be described in more detail in connection with FIG. 2). The capacitor circuit 102 may only allow a current path from the capacitor circuit 102 to conduct when a 3.3V rail (or similar voltage) is valid from a bus (e.g., a PCI-e bus that may be connected to pin 6 of FIG. 1). The circuit 100 may greatly reduce any AC coupled energy to the ground pin (e.g., pin 2 of the temperature sensor 104) of the active circuit IC (e.g., the temperature sensor circuit 104). Without one or more N-CH/P-CH FET transistors and/or associated current limiting resistors in the circuit 100 (to be described in more detail in connection with FIG. 2), a negative voltage spike may be seen on the GND pin of the temperature sensor circuit 104 when analyzed by an oscilloscope. Over time, such negative voltage spikes may cause the temperature sensor 104 to fail due to electrical over stress.

With the implementation of the control circuit on a base card (e.g., a PCIe board that may plug into a PCIe bus of a computer), the circuit 100 may ensure the energy from a fully (or partially) charged capacitor circuit 102 does not AC couple into the GND pin of the temperature sensor 104 in the capacitor circuit 102. While a PCIe board and/or PCIe bus have been described, the particular type of bus and/or interconnection used may be varied to meet the design criteria of a particular implementation. In one example, the capacitor circuit 102 may be used to provide power to a memory device (not shown). The memory device may be implemented, in one example, as a non-volatile storage device, such as a flash memory, a flash memory array, or other suitable memory module. Such a memory device may be implemented, in one example, to store cache data such as cache data from a redundant array of inexpensive disks (RAID) controller. The capacitor circuit 122 may provide sufficient energy to power the cache memory. Also, the circuit 100 may allow the capacitor circuit 102 to self discharge in a safe manner to prevent an end user from being exposed to high energy discharge (e.g., a shock). The circuit 100 may be used to control AC coupled energy from a fully (or partially) charged capacitor circuit 102 into the GND pin of the active circuit ICs (e.g., the temperature sensor circuit 104).

Referring to FIG. 2, a more detailed diagram of the capacitor circuit 102 is shown. The capacitor circuit 102 generally comprises a block (or circuit) 120, a block (or circuit) 122 and a block (or circuit) 124. The circuit 120 may be implemented as a plurality of resistors. The circuit 122 may be implemented as a plurality of capacitors. The circuit 124 may be implemented as the control circuit discussed in connection with FIG. 1. The circuit 120 generally comprises a number of resistors 130a-130n. The circuit 122 generally comprises a number of capacitors 132a-132n. The circuit 124 generally comprises a transistor 140, a transistor 142, a diode 144, a diode 146, and a resistor 148.

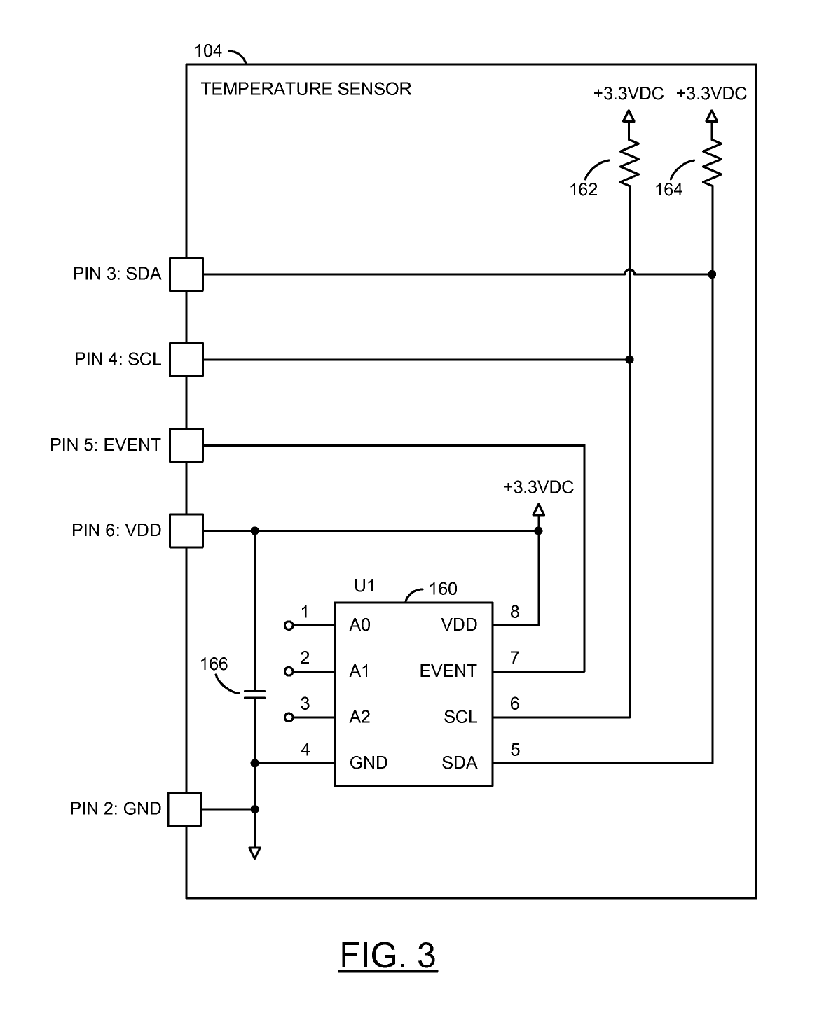

Referring to FIG. 3, a more detailed diagram of the temperature sensor 104 is shown. In one example, the temperature sensor 104 may be implemented as a part number SE97B, manufactured by NXP, On-Semiconductor, etc. However, the particular type of temperature sensor 104 implemented may be varied to meet the design criteria of the particular implementation. The temperature sensor circuit 104 generally comprises a block (or circuit) 160, a resistor 162 and a resistor 164. The resistor 162 may be connected to a supply voltage (e.g., 3.3 volts). Similarly, the resistor 164 may be connected to the supply voltage VDC. The resistor 162 may be connected to a pin 4, as well as the input 166 of the circuit 160. The resistor 164 may be connected to a pin 3 as well as to the input 5 of the circuit 160. A pin 5 may be connected to an input 7 of the circuit 160. The pin 6 may be connected to the supply voltage, as well as a pin 8 of the circuit 160. The pin 6 may also be connected to an input 4 of the circuit 160 through a capacitor 166. The pin 2 may be connected to pin 4 of the circuit 160. The circuit 104 may have a number of pins (e.g., pin 2, pin 3, pin 4, pin 5 and pin 6).

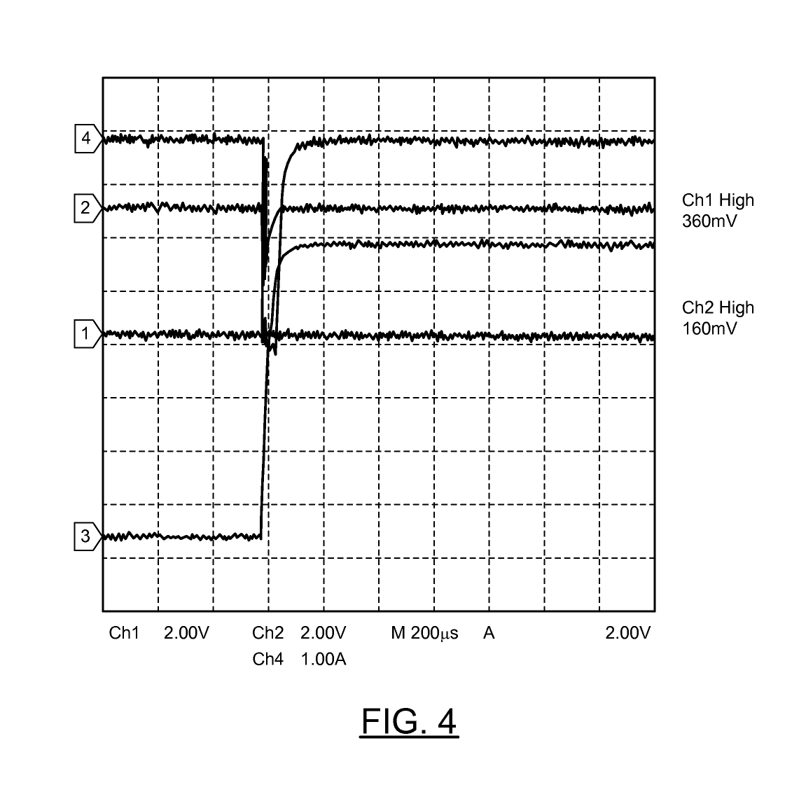

Referring to FIG. 4, a plot of the capacitor circuit 102 during a hot-plug operation without the element 124 is shown. P3V3 at the power pin of the temperature sensor circuit 104 is normally represented by VDD as a trace 1. A ground reference is shown for the temperature sensor circuit 104 as a trace 2. The charging voltage for capacitor circuit 102 is represented by a trace 3. Current of the capacitor circuit 102 is shown at the time of a hot plug event as a trace 4.

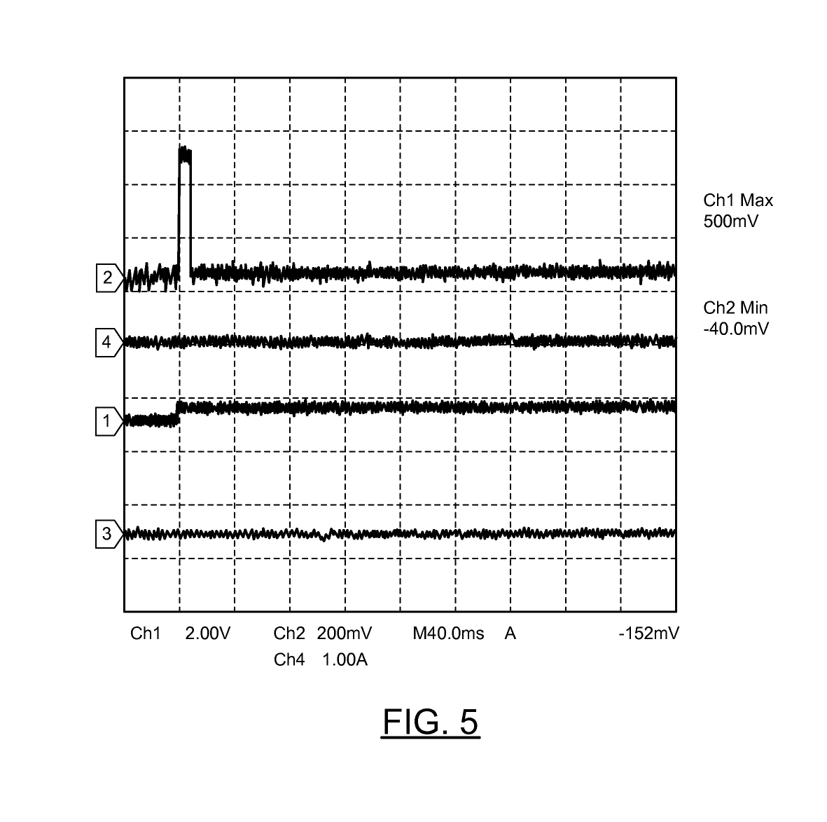

Referring to FIG. 5, a plot of the capacitor circuit 102 during a hot-plug operation with the element 124 is shown. A trace 1 shows P3V3 at the power pin of the temperature sensor circuit as represented by capacitor circuit 102. A trace 2 shows the ground pin of the capacitor circuit 102 when a hot-plug event occurs. A trace 3 shows a charging voltage for the capacitor circuit. A trace 4 shows current from the capacitor circuit 102 at the time of a hot plug event.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more integrated circuits, one or more chips or die arranged as flip-chip modules and/or multi-chip modules or by interconnecting an appropriate network of conventional component circuits, as is described herein, modifications of which will be readily apparent to those skilled in the art(s).

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to the preferred embodiments thereof, it will be understood by those skilled in the art that various changes in form and details may be made without departing from the scope of the invention.

1. An apparatus comprising:
a capacitor circuit configured to (i) be charged through an input terminal and (ii) store a charge sufficient to run a device on an output terminal; and
a control circuit configured to (i) charge said capacitor through said input terminal, (ii) couple said input terminal to a voltage source, and (iii) discharge said capacitor circuit when said output terminal is not connected to said device.

2. The apparatus according to claim 1, further comprising:
a resistor circuit configured to balance a charge of said capacitor circuit.

3. The apparatus according to claim 2, wherein said resistor circuit is further configured to discharge said capacitor circuit when said input terminal is not connected to said voltage source.

4. The apparatus according to claim 1, wherein said device comprises a computer drive.

5. The apparatus according to claim 1, wherein said device comprises a non-volatile storage device.

6. The apparatus according to claim 1, wherein said capacitor circuit comprises a plurality of capacitors connected in series.

7. The apparatus according to claim 1, wherein said capacitor circuit comprises a plurality of capacitors connected in parallel.

8. The apparatus according to claim 1, wherein said control circuit comprises a hot plot protection circuit.

9. The apparatus according to claim 1, wherein said apparatus comprises an uninterruptible power supply.

10. The apparatus according to claim 1, wherein said control circuit is mounted on a base card.

11. The apparatus according to claim 1, wherein said control circuit is mounted on a RAID controller board.

12. The apparatus according to claim 1, wherein said capacitor circuit is configured to power said device to store cache data of a RAID controller.

13. An apparatus comprising:
means for charging a capacitor circuit through an input terminal;
means for storing a charge sufficient to run a device on an output terminal; and
means for controlling (i) said charge of said capacitor through said input terminal, (ii) coupling said input terminal to a voltage source, and (iii) discharging said capacitor circuit when said output terminal is not connected to said device.

14. A method for protecting a circuit connected to a capacitor circuit, comprising the steps of:
charging said capacitor circuit through an input terminal;
storing a charge sufficient to run a device on an output terminal; and
controlling (i) said charge of said capacitor through said input terminal, (ii) coupling said input terminal to a voltage source, and (iii) discharging said capacitor circuit when said output terminal is not connected to said device.

15. The method according to claim 14, further comprising:
balancing a charge of said capacitor circuit using a resistor circuit.

16. The method according to claim 14, wherein said device comprises a computer drive.

17. The method according to claim 14, wherein said device comprises a non-volatile storage device.
